(19) United States
(12) Patent Application Publication
(10) Pub. No.: US 2014/0178791 A1
(43) Pub. Date: Jun. 26, 2014

(54) METHODS OF MAKING AND USING ELECTRODE COMPOSITIONS AND ARTICLES

(71) Applicant: GENERAL ELECTRIC COMPANY, Schnectady, NY (US)

(72) Inventors: Michael Alan VALLANCE, Niskyuna, NY (US); Brandon Alan BARTLING, Niskayuna, NY (US); Ayesha Maria GONSALVES, Niskayuna, NY (US)

(73) Assignee: GENERAL ELECTRIC COMPANY, Schenectady, NY (US)

(21) Appl. No.: 13/721,354

(22) Filed: Dec. 20, 2012

(51) Int. Cl. H01M 4/58

(52) U.S. Cl. CPC H01M 4/582
USPC 429/482; 429/321; 252/513

(57) ABSTRACT

A cathode composition is described that includes a first element selected from nickel or cobalt; a second element M selected from iron or cobalt, wherein said second element M is contained within a sulfide composition MₓS_{y}, wherein the ratio of x and y is between 0.5:1 and 1.5:1; at least one first alkali metal halide; and an electrolyte salt comprising a second alkali metal halide and a metal halide, wherein the electrolyte salt has a melting point in a range from about 150° C. to about 300° C. The molar ratio of the first element to the sulfur of the sulfide composition is between 1.5:1 and 50:1. An energy storage device comprising the cathode composition is also disclosed.

### BACKGROUND

The present disclosure generally relates to electrode compositions. In specific embodiments, the present disclosure relates to a method of making and using compositions for cathode materials. The disclosure also includes energy storage devices that utilize such cathode materials.

Metal chloride batteries with molten sodium anode and beta-alumina solid electrolyte are widely employed for energy storage applications. The energy storage application may include mobile applications due to their high energy density and long cycle life. To be applicable for mobile applications like hybrid locomotives or plug-in electric vehicles (PHEV), the sodium nickel chloride battery should tolerate power surges (high currents) at both battery charging and discharging without loss in the working capacity and the cycle life. The sodium nickel chloride batteries are used because of the high theoretical energy density (790 Wh/kg) in addition to their ability to operate over a wide temperature range. The cathode of such battery is built from nickel metal, sodium chloride NaCl and a molten secondary electrolyte, NaAlCl₄. Nickel is present in excess, and the battery theoretical capacity is determined by the amount of NaCl. A common way to improve the cell performance is an addition of a small amount of additives to the cathode composition. The use of sodium salts of other halogens (NaF, NaBr and NaI) and elemental sulfur as additives have been tried. Addition of iron monosulfide FeS instead of elemental sulfur allowed for better sulfur distribution in the electrochemical cell and less variability.

There exists a need for an improved solution to the long-standing problem of high current cell performance, particularly high charging current performance. Increasing the charging voltage does increase charging currents. However, repeated cycling at high charging voltage causes degradation of charging rate and cell capacity. Thus, it may be desirable to have an electrode material that maintains or improves the charging performance of the battery, but allows for a reduction in costs over those materials currently available.

### BRIEF DESCRIPTION

The present disclosure provides, in a first aspect, a cathode composition. The cathode composition comprises a first element selected from nickel or cobalt, a second element M selected from iron or cobalt, at least one first alkali metal halide, and an electrolyte salt comprising a second alkali metal halide and a metal halide. In these embodiments, it is not intended for cobalt to be both the first element and the second element simultaneously. The at least one first alkali metal halide and the second alkali metal halide may be the same or different. The second element M is contained within a sulfide composition MₓS_{y}, wherein the ratio of x and y is between 0.5:1 and 1.5:1. The electrolyte salt has a melting point in a range from about 150° C. to about 300° C. The molar ratio of the first element to the sulfur of the sulfide composition is between 1.5:1 and 50:1.

The present disclosure provides, in a second aspect, an article comprising a cathode. In these embodiments, the cathode comprises a first element selected from nickel or cobalt, a second element M selected from iron or cobalt, at least one first alkali metal halide, and an electrolyte salt comprising a second alkali metal halide and a metal halide. In these embodiments, it is not intended for cobalt to be both the first element and the second element simultaneously. The at least one first alkali metal halide and the second alkali metal halide may be the same or different. The second element M is contained within a sulfide composition MₓS_{y}, wherein the ratio of x and y is between 0.5:1 and 1.5:1. The electrolyte salt has a melting point in a range from about 150° C. to about 300° C. The molar ratio of the first element to the sulfur of the sulfide composition is between 1.5:1 and 50:1.

The present disclosure provides, in a third aspect, an energy storage device. The device comprises a first compartment comprising metallic alkali metal; a second compartment comprising a cathode composition; and a solid separator capable of transporting alkali metal ions between said first and second compartments. The cathode composition comprises a first element selected from nickel or cobalt, a second element M selected from iron or cobalt, at least one first alkali metal halide, and an electrolyte salt comprising a second alkali metal halide and a metal halide. In these embodiments, it is not intended for cobalt to be both the first element and the second element simultaneously. The at least one first alkali metal halide and the second alkali metal halide may be the same or different. The second element M is contained within a sulfide composition MₓS_{y}, wherein the ratio of x and y is between 0.5:1 and 1.5:1. The electrolyte salt has a melting point in a range from about 150° C. to about 300° C. The molar ratio of the first element to the sulfur of the sulfide composition is between 1.5:1 and 50:1.

This device may also include a positive electrode current collector and a negative electrode current collector. This device may be rechargeable over a plurality of cycles. An energy storage battery that comprises a plurality of such rechargeable energy storage devices constitutes another embodiment of the invention.

The present disclosure provides, in a fourth aspect, a method for the preparation of an energy storage device. This method comprises providing a positive electrode and a negative electrode, ionically connected to each other by a separator, and capable of reacting galvanically upon connection; providing an electrically-conductive electrolyte to at least the positive electrode; and providing positive and negative current collectors for attachment to the positive and negative electrodes, respectively, to direct current resulting from the galvanic reaction to a desired location. The positive electrode of this embodiment comprises a cathode composition as described supra.

These and other objects, features and advantages of this disclosure will become apparent from the following detailed description of the various aspects of the disclosure taken in conjunction with the accompanying drawings.

### BRIEF DESCRIPTION OF THE DRAWINGS

FIG. 1 shows graphical data of the energy produced per day of cells with different cathode compositions according to examples described herein at five unique testing protocols. These protocols are intended to be representative of cycling conditions that the cells would experience in an end use application.

FIG. 2a demonstrates graphical data of the average charging current over a number of cycles of cells with different cathode compositions according to examples described herein. FIG. 2b illustrates graphical data of the end of charge current over a number of cycles for some of the same cells as are shown in FIG. 2a.

### DETAILED DESCRIPTION

Each embodiment presented below facilitates the explanation of certain aspects of the disclosure, and should not be interpreted as limiting the scope of the disclosure. Moreover, approximating language, as used herein throughout the specification and claims, may be applied to modify any quantitative representation that could permissibly vary without resulting in a change in the basic function to which it is related. Accordingly, a value modified by a term or terms, such as “about,” is not limited to the precise value specified. In some instances, the approximating language may correspond to the precision of an instrument for measuring the value.

In the following specification and claims, the singular forms “a”, “an” and “the” include plural referents unless the context clearly dictates otherwise. As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

As used herein, cathodic material (or “cathode material”, “cathode composition”, “positive electrode material” or “positive electrode composition”, which may all be used interchangeably) is the material that supplies electrons during charge and is present as part of a redox reaction. Anodic material (or “anode material” or “negative electrode”) accepts electrons during charge and is present as part of the redox reaction. The cathode includes cathodic materials having differing functions: an electrode material, a support structure, and a current collector. The electrode material is present in the cathode as a participating electrochemical reactant both in its oxidized or reduced state, or at some state between full oxidation or reduction. The support structure does not undergo much (if any) chemical reaction during the charge/discharge, but does provide electron transport and support the electrode material as the electrode material undergoes chemical reaction and allows for a surface upon which solids may precipitate as needed. An electrolyte is a medium that provides the ion transport mechanism between the positive and negative electrodes of a cell, and may act as a solvent for the oxidized form of the electrode material. Additives that facilitate the ion transport mechanism, but do not themselves provide the mechanism, are distinguished from the electrolyte itself

As discussed in detail below, some of the embodiments of the present disclosure provide a cathode composition comprised of a first element, a second element M contained within a sulfide composition MₓS_{y}, at least one first alkali metal halide, and an electrolyte salt comprising a second alkali metal halide and a metal halide.

In some embodiments, the first element is nickel. In other embodiments, the first element is cobalt.

In some embodiments, the second element M is iron. In other embodiments, the second element M is cobalt. The second element M is contained within a sulfide composition MₓS_{y}, wherein the ratio of x and y is between 0.5:1 and 1.5:1. Non-limiting examples of the sulfide composition MₓS_{y} include FeS, FeS₂, CoS₂, Co₃S₄, and Co₉S₈. In certain embodiments, the sulfide composition is FeS. The person of skill will understand that x and y are not necessarily integers.

In these embodiments, cobalt is not meant to be utilized as both the first element and the second element at the same time. That is, if the first element is cobalt, the second element will be iron. If the second element M is cobalt, the first element is nickel. If the first element is nickel, the second element M may be selected from cobalt or iron. Similarly, if the second element M is iron, the first element may be selected from nickel or cobalt. In some embodiments in which the first element is nickel, there may be more than one sulfide composition MₓS_{y}; as a non-limiting example, when the first element is nickel, the sulfide composition MₓS_{y} may include both FeS and CoS. Similarly, when the second element is iron, there may be more than one first element, that is both nickel and cobalt.

In some embodiments, the molar ratio of the first element to the sulfur of the sulfide composition is between 1.5:1 and 50:1. In some embodiments, the molar ratio of the first element to the sulfur of the sulfide composition is between 5:1 and 25:1. In other embodiments, the molar ratio of the first element to the sulfur of the sulfide composition is between 5:1 and 10:1. To be perfectly clear, when the term “between 5:1 and 10:1” is used, it is meant to include all values, including non-integer values, that fall between and including 5:1 and 10:1, for instance, 5:1, 6:1, 6.2:1, 7.5:1, 8.75:1, etc.

In some embodiments, the at least one first alkali metal halide comprises sodium. In other embodiments, the at least one first alkali metal halide comprises potassium. In other embodiments, the at least one first alkali metal halide comprises lithium. In still other embodiments, the at least one first alkali metal halide comprises combinations of sodium, potassium, and/or lithium. In some embodiments, the first alkali metal halide is at least one selected from sodium chloride, sodium iodide, sodium bromide, sodium fluoride, potassium chloride, potassium iodide, potassium bromide, potassium fluoride, lithium chloride, lithium iodide, lithium bromide, lithium fluoride, cesium chloride and the like. In some embodiments, the first alkali metal halide comprises at least one of sodium chloride, sodium fluoride, and sodium iodide. In some embodiments, the first alkali metal halide comprises two or three of sodium chloride, sodium fluoride, and sodium iodide.

In some embodiments, the molar ratio of the total amount of alkali metal in the at least one first alkali metal halide to the sulfur of the sulfide composition MₓS_{y} is between 1.5:1 and 50:1. In some embodiments, the molar ratio of the total amount of alkali metal in the at least one first alkali metal halide to the sulfur of the sulfide composition MₓS_{y} is between 1.75:1 and 10:1. In some embodiments, the molar ratio of the total amount of alkali metal in the at least one first alkali metal halide to the sulfur of the sulfide composition MₓS_{y} is between 1.75:1 and 5:1. In some embodiments, the molar ratio of the total amount of alkali metal in the at least one first alkali metal halide to the sulfur of the sulfide composition MₓS_{y} is between 1.75:1 and 3:1. In some embodiments, the molar ratio of the total amount of alkali metal in the at least one first alkali metal halide to the sulfur of the sulfide composition MₓS_{y} is between 1.75:1 and 2.5:1. As above, to be perfectly clear, when the term “between 1.75:1 and 10:1” is used, it is meant to include all values, including non-integer values, that fall between and including 1.75:1 and 10:1, for instance, 2:1, 2.1:1, 3.25:1, 7.5:1, 8.75:1, etc.

In one embodiment, the metal halide may be at least one selected from aluminum halide, gallium halide, and tin halide. In one embodiment, the metal halide may be aluminum halide.

In some embodiments, the electrolyte salt comprising a second alkali metal halide and a metal halide has a melting point in a range from about 150° C. to about 300° C. In other embodiments, the electrolyte salt comprising a second alkali metal halide and a metal halide has a melting point a range from about 250° C. to about 300° C. In some embodiments, the electrolyte salt comprising a second alkali metal halide and a metal halide has a melting point in a range from about 200° C. to about 250° C. In some embodiments, the electrolyte salt comprising a second alkali metal halide and a metal halide has a melting point in a range from about 150° C. to about 200° C. In some embodiments, the electrolyte salt comprising a second alkali metal halide and a metal halide comprises at least one halogen selected from chlorine, bromine and fluorine. In some embodiments, the cathode composition further comprises aluminum. In some embodiments, the electrolyte salt comprising a second alkali metal halide and a metal halide comprises sodium chloride and aluminum chloride in a molar ratio from about 0.53:0.48 to 0.45:0.55.

In some embodiments, the first element is nickel; the sulfide composition is FeS; the first alkali metal halide comprises at least one of sodium chloride, sodium fluoride, and sodium iodide; and the electrolyte salt comprising a second alkali metal halide and a metal halide is NaAlCl₄.

In some embodiments, the first alkali metal halide comprises at least one of sodium chloride, sodium fluoride, and sodium iodide; and the sulfide composition is FeS. In some embodiments, the first alkali metal halide comprises sodium chloride, sodium fluoride, and sodium iodide; and the sulfide composition is FeS.

In some embodiments, an article is disclosed that comprises a cathode comprising a cathode composition. The cathode composition comprises a first element selected from nickel or cobalt, a second element M selected from iron or cobalt, at least one first alkali metal halide, and an electrolyte salt comprising a second alkali metal halide and a metal halide. In these embodiments, it is not intended for cobalt to be both the first element and the second element simultaneously. The at least one first alkali metal halide and the second alkali metal halide may be the same or different. The second element M is contained within a sulfide composition MₓS_{y}, wherein the ratio of x and y is between 0.5:1 and 1.5:1. The electrolyte salt has a melting point in a range from about 150° C. to about 300° C. The molar ratio of the first element to the sulfur of the sulfide composition is between 1.5:1 and 50:1. In some embodiments, the article is an energy storage device.

The embodiments described herein allow for operation of a cell that utilizes the cathode more cost-effectively by using a less expensive material to achieve the same goal. For instance, the cathode of a conventional cell often contains over 140 grams of nickel. Embodiments of this disclosure, however, contain reduced amounts of nickel, often less than 100 grams. In both cell designs, nickel serves as the electronic conduction grid. Nickel (II) chloride is not an electronic conductor, so additional nickel is included in the as-built conventional cell to account for the loss of conductivity upon nickel oxidation. In embodiments contained herein, however, a significant fraction of nickel is oxidized to heazlewoodite (Ni₃S₂) during charging, which is an electronic conductor. Similarly, conventional cells may contain less than 5 grams of troilite (FeS), while embodiments contained herein may contain at least ten times that amount.

In one embodiment, the cathode composition may include other additives that may affect performance. Such performance additives may increase ionic conductivity, increase or decrease solubility of the charged cathodic species, improve wetting of the solid electrolyte by the molten electrolyte, or prevent ripening of the cathode microdomains, to name several utilities. Usually, though not always, the performance additive is present in an amount that is less than about 1 weight percent, based on the total weight of the positive electrode composition. Examples of such additives include one or two additional metal halides, e.g., sodium fluoride or sodium bromide.

Another embodiment disclosed is directed to an article that includes a cathode composition, as described herein. As one example, the article may be in the form of an energy storage device. The device usually comprises (a) a first compartment comprising an alkali metal; (b) a second compartment including a cathode composition, as described herein; and (c) a solid separator capable of transporting alkali metal ions between the first and the second compartments.

The device also includes a housing that usually has an interior surface defining a volume. The housing of the electrochemical cell can be sized and shaped to have a cross-sectional profile that is square, polygonal, or circular, for example. Typically, the aspect ratio of the housing is determined by the aspect ratio of the separator. In many cases, the walls of the separator should be relatively slender, to reduce the average ionic diffusion path length. In one embodiment, the height to effective diameter ratio (2×(square root of (cross-sectional area/pi)) of the housing is greater than about 5. In some other embodiments, the ratio is greater than about 7. The housing can be formed from a material that is a metal, ceramic, or a composite; or some combination thereof. The metal can be selected from nickel or steel, as examples; and the ceramic is often a metal oxide.

Typically, the anode compartment is empty in the ground state (uncharged state) of the electrochemical cell. The anode is then filled with metal from reduced metal ions that move from the positive electrode compartment to the anode compartment through the separator, during operation of the cell. The anodic material, (e.g., sodium) is molten during use. The first compartment (usually the anode compartment) may receive and store a reservoir of anodic material.

Additives suitable for use in the anodic material may include a metallic oxygen scavenger. Suitable metal oxygen scavengers may include one or more of manganese, vanadium, zirconium, aluminum, or titanium. Other useful additives may include materials that increase wetting of the separator surface defining the anode compartment, by the molten anodic material. Additionally, some additives or coatings may enhance the contact or wetting between the separator and the current collector, to ensure substantially uniform current flow throughout the separator.

The separator is usually an alkali metal ion conductor solid electrolyte that conducts alkali metal ions during use between the first compartment and the second compartment. Suitable materials for the separators may include an alkali-metal-beta-alumina, alkali-metal-beta″-alumina, alkali-metal-beta′-gallate, or alkali-metal-beta″-gallate. In various embodiments, the solid separator may include a beta-alumina, a beta″-alumina, a gamma alumina, or a micromolecular sieve such as, for example, a tectosilicate, such as a feldspar, or a feldspathoid. Other exemplary separator materials include zeolites, for example a synthetic zeolite such as zeolite 3A, 4A, 13X, ZSM-5; rare-earth silicophosphates; silicon nitride; or a silicophosphate; a beta′-alumina; a beta″-alumina; a gamma alumina; a micromolecular sieve; or a silicophosphate (NASICON: Na₃Zr₂Si₂PO₁₂).

In some embodiments, the separator includes a beta alumina. In one embodiment, a portion of the separator is alpha alumina, and another portion of the separator is beta alumina. The alpha alumina, a non-ionic-conductor, may help with sealing and/or fabrication of the energy storage device.

The separator may be stabilized by the addition of small amounts of a dopant. The dopant may include one or more oxides selected from lithia, magnesia, zinc oxide, and yttria. These stabilizers may be used alone or in combination with themselves, or with other materials. In one embodiment, the separator comprises a beta alumina separator electrolyte (BASE), and may include one or more dopants.

The separator is disposed within the volume of the housing. The separator can be sized and shaped to have a cross-sectional profile that may be an ellipse, triangle, cross, star, circle, cloverleaf, rectangular, square, or multi-lobal, to provide a maximum surface area for alkali metal ion transport. Similarly, the separator may include a shape which may be flat, undulated, domed or dimpled. A planar configuration (or one with a slight dome) may be useful in a prismatic or button-type battery configuration, where the separator is domed or dimpled. The separator can have a width to length ratio that is greater than about 1:10, along a vertical axis. In one embodiment, the length to width ratio of the separator is in a range of from about 1:10 to about 1:5, although other relative dimensions are possible, as described in Ser. No. 13/034,184. The ionic material transported across the separator between the anode compartment and the positive electrode compartment can be an alkali metal. Suitable ionic materials may include cationic forms of one or more of sodium, lithium and potassium.

The separator has a first surface that defines at least a portion of a first compartment, and a second surface that defines a second compartment. The first compartment is in ionic communication with the second compartment through the separator. As used herein, the phrase “ionic communication” refers to the traversal of ions between the first compartment and the second compartment, through the separator. The separator can be a tubular container in one embodiment, having at least one wall. The wall can have a selected thickness; and an ionic conductivity. The resistance across the wall may depend in part on that thickness. In some cases, the thickness of the wall can be less than about 5 millimeters. A cation facilitator material can be disposed on at least one surface of the separator, in one embodiment. The cation facilitator material may include, for example, selenium, as discussed in published U.S. Patent Application No. 2010/0086834, incorporated herein by reference.

In some embodiments, one or more shim structures can be disposed within the volume of the housing. The shim structures support the separator within the volume of the housing. The shim structures can protect the separator from vibrations caused by the motion of the cell during use, and thus reduce or eliminate movement of the separator relative to the housing. In one embodiment, a shim structure functions as a current collector.

In most embodiments, the energy storage device described herein may have a plurality of current collectors, including negative (e.g., anode) current collectors, and positive electrode current collectors. The anode current collector is in electrical communication with the anode chamber, and the positive electrode current collector is in electrical communication with the contents of the positive electrode chamber. Suitable materials for the anode current collector include iron, steel, aluminum, tungsten, titanium, nickel, copper, molybdenum, and combinations of two or more of the foregoing metals. Other suitable materials for the anode current collector may include carbon. The positive electrode current collector may be in various forms, e.g., rod, a sheet, wire, paddle may or mesh, formed from platinum, palladium, gold, nickel, copper, carbon, or titanium. The current collector may be plated or clad. In one embodiment, the current collector is free of iron.

As described for some embodiments in U.S. application Ser. No. 13/034,184, referenced above, at least one of the alkali metals in the positive electrode may be sodium, and the separator may be beta-alumina. In another embodiment, the alkali metal may be potassium or lithium, with the separator then being selected to be compatible therewith. For example, in embodiments where the ions include potassium, silver, strontium, and barium cations, the separator material may include beta alumina. In certain other embodiments, where lithium cations are used, a lithiated borophosphate BPO₄—Li₂O, may be employed as the separator material.

A plurality of the electrochemical cells (each of which may be considered a rechargeable energy storage device) can be organized into an energy storage system, e.g., a battery. Multiple cells can be connected in series or parallel, or in a combination of series and parallel. For convenience, a group of coupled cells may be referred to as a module or pack. The ratings for the power and energy of the module may depend on such factors as the number of cells, and the connection topology in the module. Other factors may be based on end-use application specific criteria.

In some particular embodiments, the energy storage device is in the form of a battery backup system for a telecommunications (“telecom”) device, sometimes referred to as a telecommunication battery backup system (TBS). The device could be used in place of (or can complement) the well-known, valve-regulated lead-acid batteries (VRLA) that are often used in a telecommunications network environment as a backup power source. Specifications and other system and component details regarding TBS systems are provided from many sources, such as OnLine Power's “Telecommunication Battery Backup Systems (TBS)”; TBS-TBS6507A-8/3/2004 (8 pp); and “Battery Backup for Telecom: How to Integrate Design, Selection, and Maintenance” ; J. Vanderhaegen; 0-7803-8458-X/04, ©2004 IEEE (pp. 345-349). Both of these references are incorporated herein by reference.

In other embodiments, the energy storage device is in the form of an uninterruptable power supply device (UPS). The primary role of most UPS devices is to provide short-term power when the input power source fails. However, most UPS units are also capable in varying degrees of correcting common utility power problems, such as those described in patent application Ser. No. 13/034,184. The general categories of modern UPS systems are on-line, line-interactive, or stand-by. An on-line UPS uses a “double conversion” method of accepting AC input, rectifying to DC for passing through the rechargeable battery, then inverting back to 120V/230V AC for powering the protected equipment. A line-interactive UPS maintains the inverter in line and redirects the battery's DC current path from the normal charging mode to supplying current when power is lost. In a standby system, the load is powered directly by the input power; and the backup power circuitry is only invoked when the utility power fails. UPS systems including batteries having electrode compositions as described above may be ideal in those situations where high energy density within the battery is a requirement.

Another embodiment disclosed is directed to a method for the preparation of an energy storage device, as mentioned previously. In some specific embodiments, the method comprises providing a housing having an interior surface defining a volume; disposing a separator inside the housing, wherein the separator has a first surface that defines at least a portion of a first compartment, and a second surface that defines a second compartment. The first compartment is in ionic communication with the second compartment through the separator. The method includes the step of preparing a cathode composition as described herein and disposing this material in the second compartment. Other steps to fully fabricate the device can then be undertaken, e.g., filling the cathode compartment with electrolyte, compartment-sealing steps, electrical connection steps, and the like. The method may include taking the battery or other type of energy storage device through a plurality of charge/discharge cycles, to activate or condition the positive electrode composition material.

The energy storage devices illustrated herein may be rechargeable over a plurality of charge-discharge cycles. In another embodiment, the energy storage device may be employed in a variety of applications; and the plurality of cycles for recharge is dependent on factors such as charge and discharge current, depth of discharge, cell voltage limits, and the like.

The energy storage system described herein can usually store an amount of energy that is in a range of from about 0.1 kiloWatt hour (kWh) to about 100 kWh. An illustration can be provided for the case of a sodium-nickel chloride energy storage system (i.e., a battery) with a molten sodium anode and a beta-alumina solid electrolyte, operating within the temperature range noted above. In that instance, the energy storage system has an energy-by-weight ratio of greater than about 100 Watt-Hours per kilogram, and/or an energy-by-volume ratio of greater than about 200 Watt-Hours per liter. Another embodiment of the energy storage system has a specific power rating of greater than about 200 Watts per kilogram; and/or an energy-by-volume ratio of greater than about 500 Watt-Hours per liter. Suitable energy storage system may have an application specific Power to Energy ratio of less than 10 to 1 hour⁻¹. In one embodiment, the specific power to energy ratio is in range from about 1:1 to about 2:1, from about 2:1 to about 4:1, from about 4:1 to about 6:1, from about 6:1 to about 8:1, or from about 8:1 to about 10:1. In other embodiments, the power to energy ratio is in range from about 1:1 to about 1:2, from about 1:2 to about 1:4, from about 1:4 to about 1:6, from about 1:6 to about 1:8, or from about 1:8 to about 1:10.

It should be noted that the energy term here is defined as the product of the discharge capacity multiplied by the thermodynamic potential. The power term is defined as the power available on a constant basis, for 15 minutes of discharge, without passing through a voltage threshold sufficiently low to reduce the catholyte.

Other features associated with the energy storage system may constitute embodiments of this disclosure; and some are described in the referenced application Ser. No. 13/034,184. As an example, the system can include a heat management device to maintain the temperature within specified parameters. The heat management device can warm the energy storage system if too cold, and can cool the energy storage system if too hot, to prevent an accelerated cell degradation. The heat management system includes a thaw profile that can maintain a minimal heat level in the anode and positive electrode chambers, to avoid freezing of cell reagents.

Some other embodiments are directed to an energy management system that includes a second energy storage device that differs from the first energy storage device. This dual energy storage device system can address the ratio of power to energy, in that a first energy storage device can be optimized for efficient energy storage, and the second energy storage device can be optimized for power delivery. The control system can draw from either energy storage device as needed, and charge back either energy storage device that needs such a charge.

Some of the suitable second energy storage devices for the power platform, include a primary battery, a secondary battery, a fuel cell, and/or an ultracapacitor. A suitable secondary battery may be a lithium battery, lithium ion battery, lithium polymer battery, or a nickel metal hydride battery.

### EXAMPLES

The examples presented below are intended to be merely illustrative and should not be construed to be any sort of limitation on the scope of the claimed invention. Unless specified otherwise, all of the components are commercially available from common chemical suppliers.

### Cathode Composition:

The sodium chloride (Custom Powders LTD, UK, 99.99% purity) was heat treated at 220° C. and had a particle size distribution with 90% by mass less than 75 μm, by sieve analysis. Nickel powder (Vale 255, 97.9% pure, 0.6 m²/g, 2.2-2.8 μm particle size), sodium chloride, aluminum powder (Alfa Aesar Item #42919, −100+325 mesh, 99.97%) and iron sulfide powder (Alfa Aesar, 99.9%), along with as-received sodium iodide, sodium fluoride and iron powders, were dry mixed and cold rolled at an effective pressure of about 110-115 bar using an Alexanderwerk WP50N/75 Roll Compactor. The compacted ribbon was passed through a classifier mill to form cathode granules, and the granule fraction between 0.325-1.5 mm in size, as separated by sieve set, was used for cell assembly.

### Preparation of Electrochemical Cell

Anhydrous, high-purity sodium tetrachloroaluminate was used as received (Aldrich #451584).

Electrochemical cells used commercial hardware (GE Energy Storage Technology ML/3, Revision 2). A closed-end, β″ alumina, separator tube, with cloverleaf cross-section separated the inner cathode compartment from the outer anode compartment. The outer wall of the anode was a carbon steel can, with square profile. The can size was about 38 mm×38 mm×230 mm. The steel can was the current collector for the anode. A central U-shaped nickel rod was the current collector for the cathode. High temperature, hermetic seals were applied to the open top ends of the cathode and the anode. Details of this construction can be found in J. L. Sudworth, J. Power Sources 100 (2001) 149-163.

The cathode granules, prepared using the procedure mentioned above, were placed in the cloverleaf shaped β″-alumina tube through a fill hole at the top of the cell assembly, and the granule bed was densified by mechanical vibration. The cathode was then infiltrated with molten sodium tetrachloroaluminate NaAlCl₄ through the same fill hole at a temperature of about 280° C. and the fill hole was closed with a welded cap. Nickel tabs were brazed to the fill-hole cap and the steel can for electrification.

### Cell Test Protocol

All cells were assembled in the discharged state. Two different testing protocols were used.

The protocol was representative of five different duty cycles.
1. Starting at 100 mA and ramping up to 2.75 A over time, charge to 2.67V, then at 2.67V to a current of 500 mA, while at 330° C.
2. Reduce temperature to 300° C. and discharge at −4.5 A to 2.2V.
3. Charge at 10 A to 2.67V, then at 2.67V down to 500 mA.
4. Discharge at −13 W to 2.1V.
5. Charge at 10 A to 2.67V, then at 2.67V down to 500 mA.
6. Discharge at −13 W for 4 hours or to 2.1V.
7. Charge at 20 A to 2.67V, then at 2.67V down to 500 mA.
8. Repeat steps 6 and 7 an additional 19 times.
9. Discharge at −13 W for 6 hours or to 2.1V.
10. Charge at 20 A to 2.67V, then at 2.67V down to 500 mA.
11. Discharge at −14 W to 2.1V.
12. Charge at 10 A to 2.67V, then at 2.67V down to 500 mA.
13. Discharge at −14 W for 28 Ah.
14. Charge at 20 A to 2.67V, then at 2.67V for a total of 13.5 Ah.
15. Discharge at −14 W for 13.5 Ah.
16. Repeat steps 14 and 15 an additional 24 times.
17. Discharge at −14 W for 2 hours or to 2.1V.
18. Charge at 20 A to 2.67V, then at 2.67V down to 500 mA.
19. Discharge at −21 W for 28 Ah.
20. Charge at 20 A to 2.67V, then at 2.67V for a total of 13.5 Ah.
21. Discharge at −21 W for 13.5 Ah.
22. Repeat steps 20 and 21 an additional 25 times.
23. Discharge at −21 W for 2 hours or to 2V.
24. Charge at 20 A to 2.67V, then at 2.67V down to 500 mA.
25. Discharge at −21 W to 2V
26. Charge at 10 A to 2.67V, then at 2.67V down to 500 mA.
27. Discharge at −21 W for 3 hours or to 2V.
28. Charge at 20 A to 2.67V, then at 2.67V down to 500 mA.
29. Repeat steps 27 and 28 an additional 19 times.
30. Discharge at −21 W for 5 hours or to 2V.
31. Charge at 20 A to 2.67V, then at 2.67V down to 500 mA.
32. Discharge at −23 W for 4 hours or to 2V.
33. Charge at 23 W to 2.67V, then at 2.67V down to 500 mA.
34. Repeat steps 32 and 33 an additional 14 times.
35. Discharge at −4.5 A to 2.2V
36. Charge at 10 A to 2.67V, then at 2.67V down to 500 mA.

Step 1 is the maiden charge, which starts at low current to avoid excessive current densities during the initial production of sodium in the negative electrode. Step 2 is an initial capacity check at 4.5A. Steps 3 and 4 are a capacity check at 13 W. Steps 6 and 7 are an initial performance measurement on a 13 W, 4 hour TOC (top of charge) cycle. Step 9 is an extended 13 W discharge to check that the cell can discharge an additional 2 hours after the 4 hour discharge. Step 11 is a capacity check at 14 W. Steps 13 through 15 are an initial performance measurement on a 14 W, PSOC (partial state of discharge) cycle. Step 17 is an extended 14 W discharge to check that the cell can discharge an additional 2 hours after the PSOC discharge. Steps 19 through 21 are an initial performance measurement on a 21 W, PSOC cycle. Step 23 is an extended 21 W discharge to check that the cell can discharge an additional 2 hours after the PSOC discharge. Step 25 is a capacity check at 21 W. Steps 27 and 28 are an initial performance measurement on a 21 W, 3 hour TOC cycle. Step 30 is an extended 21 W discharge to check that the cell can discharge an additional 2 hours after the 3 hour discharge. Steps 32 and 33 are an initial performance measurement on a 23 W charge, 23 W discharge, 4 hour TOC cycle. Step 35 is a final capacity check at 4.5 A.

The cathode compositions of the control cell (Ni5) and four experimental nickel/sodium chloride based energy cells (FC1, FC2, FC3, FC4) are shown in Table 1.

TABLE 1

| Compo- | Cathode composition (weight percentage of total cathode input) | | | | |
|---|---|---|---|---|---|
| nent | Ni5 Control | FC1 | FC2 | FC3 | FC4 |
| Ni | 52.0 | 44.9 | 29.0 | 34.3 | 37.8 |
| NaCl | 38.6 | 29.8 | 36.1 | 34.9 | 34.1 |
| NaF | 1.5 | 1.4 | 1.5 | 1.5 | 1.5 |
| Al | 0.5 | 0.5 | 0.5 | 0.5 | 0.5 |
| Fe | 0.4 | 0.7 | 0.4 | 0.4 | 0.4 |
| NaI | 5.4 | 0.4 | 0.4 | 0.4 | 0.4 |
| FeS | 1.6 | 22.4 | 32.0 | 28.0 | 25.4 |
| Total | 100.0 | 100.0 | 100.0 | 100.0 | 100.0 |

Electrochemical cells containing the cathode compositions shown in Table 1 were constructed and tested. These examples had substantially similar components, except for the proportions of sulfur to the first element (nickel) and/or the alkali metal (sodium) in the first alkali metal halide.

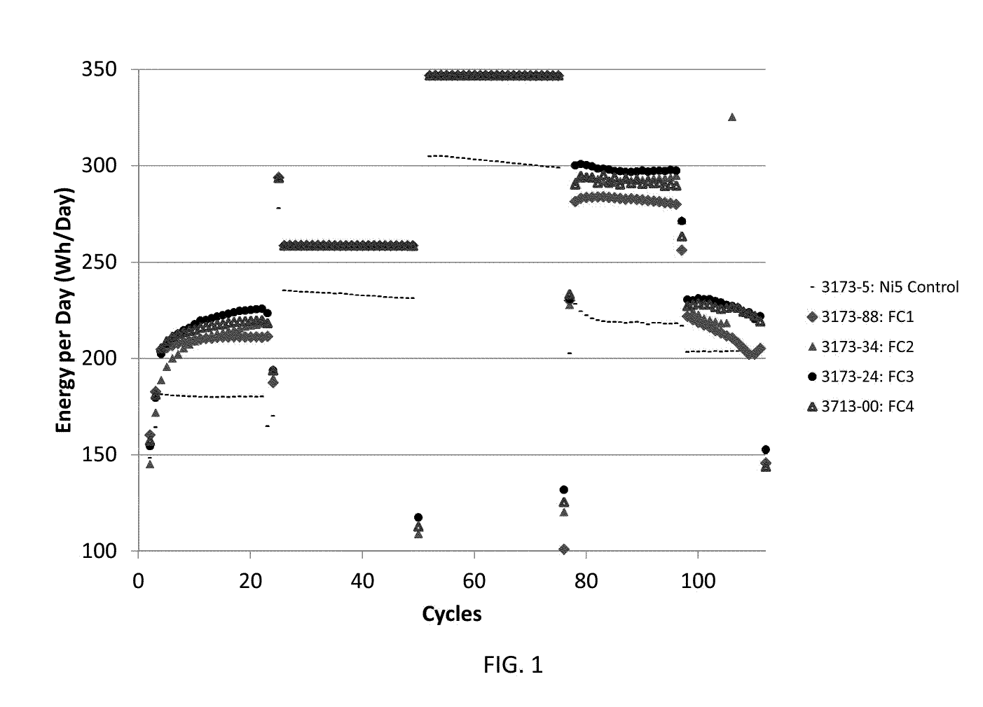

As shown in FIG. 1, an improvement in the amount of energy per day is observed in the cells containing a higher percentage of FeS in relation to nickel than in the control cell for all five cycling regimes.

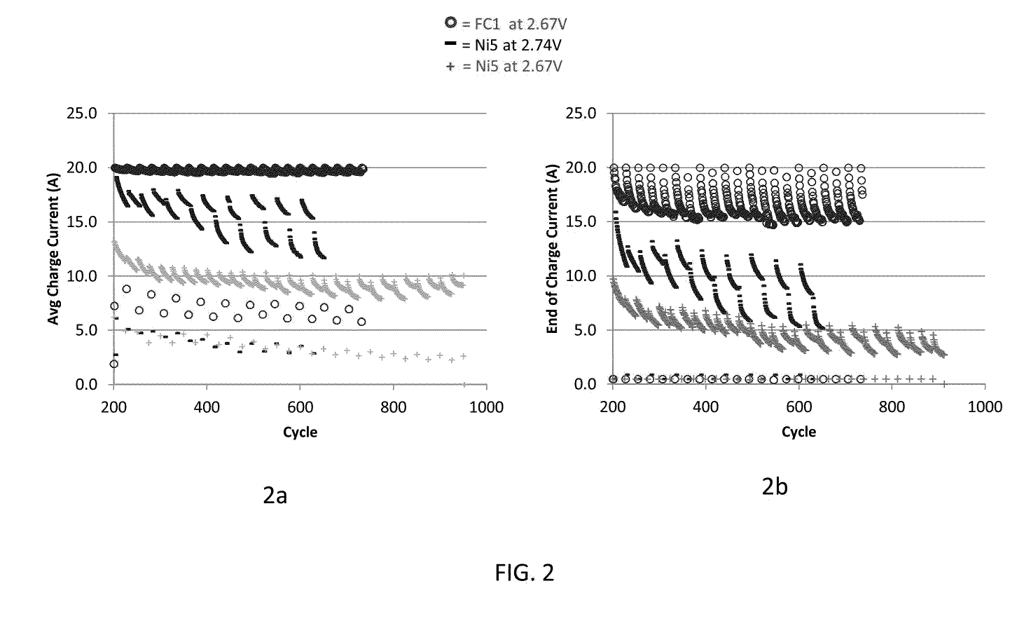

The inventive compositions also demonstrate advantageous retention of performance during repeated cycling. The FIG. 2 data were measured during long-term PSOC cycling with 15 W discharge for two of the compositions listed above. Note that capacity check cycles were inserted after every 25 cycles. In FIG. 2, it can be seen that performance tends to improve immediately following a capacity check schedule, although the improvement is not long lasting. FIG. 2a demonstrates that the average charging current for FC1 (an experimental cell as disclosed herein) charging at 2.67V maximum voltage is greater, and more stable, than for the control Ni5 cells, at either 2.67V or 2.74V maximum charging voltage. FIG. 2b illustrates that the current at the end of charge declines over 25 cycles for these chemistries, but can be recovered fully for inventive cell FC1 and partially for the control cell Ni5.

While several aspects of the present disclosure have been described and depicted herein, alternative aspects may be effected by those skilled in the art to accomplish the same objectives. Accordingly, it is intended by the appended claims to cover all such alternative aspects as fall within the true spirit and scope of the disclosure.

The present invention has been described in terms of some specific embodiments. They are intended for illustration only, and should not be construed as being limiting in any way. Thus, it should be understood that modifications can be made thereto, which are within the scope of the invention and the appended claims. Furthermore, all of the patents, patent applications, articles, and texts which are mentioned above are incorporated herein by reference.

What is claimed is:

1. A cathode composition comprising:
a first element selected from nickel or cobalt;
a second element M selected from iron or cobalt, wherein said second element M is contained within a sulfide composition MₓS_{y}, wherein the ratio of x and y is between 0.5:1 and 1.5:1;
at least one first alkali metal halide; and
an electrolyte salt comprising a second alkali metal halide and a metal halide, wherein the electrolyte salt has a melting point in a range from about 150° C. to about 300° C.;
wherein the molar ratio of the first element to the sulfur in the sulfide composition is between 1.5:1 and 50:1;
wherein cobalt cannot be both the first element and the second element; and
wherein the at least one first alkali metal halide and the second alkali metal halide may be the same or different.

2. The cathode composition according to claim 1, wherein the first element is nickel.

3. The cathode composition according to claim 1, wherein the second element is iron.

4. The cathode composition according to claim 1, wherein the sulfide composition MₓS_{y} is selected from FeS, FeS₂, CoS₂ or Co₃S₄.

5. The cathode composition according to claim 4, wherein the sulfide composition MₓS_{y} is FeS.

6. The cathode composition according to claim 1, wherein the at least one first alkali metal halide comprises sodium, potassium, lithium or combinations thereof.

7. The cathode composition according to claim 1, wherein the electrolyte salt comprises at least one halogen selected from chlorine, iodine, bromine and fluorine.

8. The cathode composition according to claim 1, wherein the electrolyte salt comprises sodium chloride and aluminum chloride in a molar ratio from about 0.53:0.48 to 0.45:0.55.

9. The cathode composition according to claim 1, wherein the molar ratio of the first element to the sulfur of the sulfide composition is between 5:1 and 25:1.

10. The cathode composition according to claim 9, wherein the molar ratio of the first element to the sulfur of the sulfide composition is between 5:1 and 10:1.

11. The cathode composition according to claim 1, wherein
the first element is nickel;
the sulfide composition is FeS;
the first alkali metal halide comprises at least one of NaCl, NaF, NaBr and NaI; and
the electrolyte salt is NaAlCl₄.

12. The cathode composition according to claim 1, wherein the molar ratio of the total amount of said first alkali metal to the sulfur of the sulfide composition is between 1.75:1 and 10:1.

13. The cathode composition according to claim 12, wherein
a. The first alkali metal halide comprises at least one of NaCl, NaF, and NaI; and
b. the sulfide composition is FeS.

14. An article comprising a cathode, wherein the cathode comprises:
a first element selected from nickel or cobalt;
a second element M selected from iron or cobalt, wherein said iron or cobalt is contained within a sulfide composition MₓS_{y}, wherein the ratio of x and y is between 0.5:1 and 1.2:1;
at least one first alkali metal halide; and
an electrolyte salt comprising a second alkali metal halide and a metal halide, wherein the electrolyte salt has a melting point in a range from about 150° C. to about 300° C.;
wherein the molar ratio of the first element to the sulfur of the sulfide composition is between 1.5:1 and 50:1;
wherein cobalt cannot be both the first element and the second element; and
wherein the at least one first alkali metal halide and the second alkali metal halide may be the same or different.

15. The article according to claim 14 wherein the article is an energy storage device.

16. The article according to claim 14, wherein the first element is nickel and the sulfide composition is FeS.

17. An energy storage device comprising:
(a) a first compartment comprising metallic alkali metal;
(b) a second compartment comprising a cathode composition, said cathode composition comprising:
(i) a first element selected from nickel or cobalt;
(ii) a second element M selected from iron or cobalt, wherein said iron or cobalt is contained within a sulfide composition MₓS_{y}, wherein the ratio of x and y is between 0.5:1 and 1.5:1;
(iii) at least one first alkali metal halide; and
(iv) an electrolyte salt comprising a second alkali metal halide and a metal halide, wherein the electrolyte salt has a melting point in a range from about 150° C. to about 300° C.;
wherein the molar ratio of the first element to the sulfur of the sulfide composition is between 1.5:1 and 50:1;
wherein cobalt cannot be both the first element and the second element; and
wherein the at least one first alkali metal halide and the second alkali metal halide may be the same or different; and
(c) a solid separator capable of transporting alkali metal ions between said first and second compartments.

18. The energy storage device according to claim 17, wherein said device is rechargeable over a plurality of cycles.

19. The energy storage device according to claim 17, wherein said solid separator comprises a beta-alumina, a beta″-alumina, a gamma alumina, a micromolecular sieve, a silicon nitride, a silicophosphate, or nasicon.

20. The energy storage device according to claim 17, wherein said solid separator comprises a shape which is flat, undulate, domed or dimpled, or comprises a shape with a cross-sectional profile that is an ellipse, triangle, cross, star, circle, cloverleaf, rectangular, square, or multi-lobal.

21. The energy storage device according to claim 17, wherein the first element is nickel and the sulfide composition is FeS.
